(19) United States
(12) Patent Application Publication
(10) Pub. No.: US 2010/0153469 A1
(43) Pub. Date: Jun. 17, 2010

(54) ELECTRONIC DEVICE AND METHOD OF CREATING A SEQUENCE OF CONTENT ITEMS

(75) Inventors: Martin Franciscus Mckinney, Eindhoven (NL); Dirk Jeroen Breebaart, Eindhoven (NL); Frederik Johan Leon Leemans, Leuven (BE)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., Eindhoven (NL)

(21) Appl. No.: 11/993,301

(22) PCT Filed: Jun. 29, 2006
(86) PCT No.: PCT/IB06/52172

§ 371 Date: Dec. 20, 2007

(30) Foreign Application Priority Data
Jun. 30, 2005 (EP) 05105899.8

(51) Int. Cl. G06F 17/30

(52) U.S. Cl. 707/803; 707/E17.005; 707/E17.009

(57) ABSTRACT

The method of creating a sequence of content items of the invention comprises a first step of determining a second content item having a second value (51) for a feature, the second value lying within a predetermined distance from a first intermediate value (42). A second step comprises determining a third content item having a third value (55) for the feature, the third value lying within a predetermined distance from a second intermediate value (46). Both the first intermediate value (42) and the second intermediate value (46) lie between a first value (41) of the feature and a fourth value (47) of the feature, the first value being designated for a first content item and the fourth value being designated for a fourth content item. The first intermediate value (42) lies closer to the first value (41) than to the fourth value (47) and the second intermediate value (46) lies closer to the fourth value (47) than to the first value (41). A third step comprises creating a sequence of content items, the sequence of content items comprising the second content item and the third content item. The third content item succeeds the second content item in the sequence. The electronic device of the invention comprises electronic circuitry which is operative to perform the method of the invention. The software of the invention enables a programmable device to perform the method of the invention.

The invention relates to a method of creating a sequence of content items, e.g. a playlist of songs.

The invention also relates to software for making a programmable device operative to perform a method of creating a sequence of content items.

The invention further relates to an electronic device comprising electronic circuitry, the electronic circuitry being operative to create a sequence of content items.

The invention also relates to electronic circuitry for use in an electronic device, the electronic circuitry being operative to create a sequence of content items.

An example of such an electronic device is known from US2003/0183064. The invention described in US2003/0183064 relates to a sequential playback system which is configured to select each sequential song based upon characteristics of an ending segment of each preceding song. Songs are selected on the basis of the characteristics of the overall theme of the selection, if any, and also on the basis of musical correspondence between songs. It is a drawback of this method that only similar songs are selected for inclusion in the sequence of songs.

It is a first object of the invention to provide an electronic device of the type described in the opening paragraph, which is capable of creating a sequence of content items, not all of which are similar, but which sequence can be mixed in a relatively easy way.

It is a second object of the invention to provide a method of the type described in the opening paragraph, which is capable of creating a sequence of content items, not all of which are similar, but which sequence can be mixed in a relatively easy way.

According to the invention, the first object is achieved in that the electronic circuitry is operative to determine a second content item having a second value for a feature, the second value lying within a predetermined distance from a first intermediate value, the first intermediate value lying between a first value of the feature and a fourth value of the feature, the first value being designated for a first content item and the fourth value being designated for a fourth content item, determine a third content item having a third value for the feature, the third value lying within a predetermined distance from a second intermediate value, the second intermediate value lying between the first value and the fourth value, the first intermediate value lying closer to the first value than to the fourth value and the second intermediate value lying closer to the fourth value than to the first value, and create a sequence of content items, the sequence of content items comprising the second content item and the third content item, the third content item succeeding the second content item in the sequence.

The electronic circuitry is thus capable of creating a sequence of content items, in which a subsequent content item is somewhat similar to the previous content item (thereby making mixing relatively easy), but in which the first and the last content items are not very similar. For songs, the result is a playlist that slowly passes from the acoustic style of a ‘start’-song to that of any anchor songs and finally to that of the ‘end’-song. Features that can be used are, for example, tempo and percussiveness of songs. Some other (mainly low-level) audio features are described in PCT Patent Publication WO 2004/095315, herein incorporated by reference. Although it would be possible with certain features (e.g. tempo) to allow a user to select a starting feature value and an ending feature value for a sequence of content items (e.g. for a playlist of songs), this is not possible or desirable for most features.

In an embodiment of the electronic device of the invention, the sequence of content items further comprises the first content item and the fourth content item, the second content item succeeding the first content item in the sequence and the fourth content item succeeding the third content item in the sequence. Although it is not necessary to have the sequence comprise the first content item and the fourth content item, a larger sequence is often preferable.

The electronic circuitry may be operative to enable a user to select at least one of a content item to be used as the first content item and a content item to be used as the fourth content item. By enabling the user to select a ‘start’ content item and/or an ‘end’ content item (e.g. songs), the user has a relatively high degree of influence on the generated sequence (e.g. a playlist). The user could also be allowed to select one or more intermediate ‘anchor’ content items. Alternatively or additionally, the electronic circuitry itself could select a ‘start’ content item and/or ‘end’ content item, e.g. based on user preference and/or based on whether a content item has extreme (e.g. maximum or minimum) values for one or more features.

The feature may comprise a plurality of features. Although the electronic circuitry could select a single feature, e.g. based on which feature has the largest increase or decrease in value between the first content item and the fourth content item, a large variation in the value of a feature is not necessarily perceived as a large variation in content when this feature is used in isolation. By using a plurality of features, the likelihood that a large variation in the feature value is perceived as a large variation in content, increases.

The content items may be songs. Although it would be possible to create a sequence of TV programs, it is more common to mix songs.

According to the invention, the second object is achieved in that the method comprises the steps of determining a second content item having a second value for a feature, the second value lying within a predetermined distance from a first intermediate value, the first intermediate value lying between a first value of the feature and a fourth value of the feature, the first value being designated for a first content item and the fourth value being designated for a fourth content item, determining a third content item having a third value for the feature, the third value lying within a predetermined distance from a second intermediate value, the second intermediate value lying between the first value and the fourth value, the first intermediate value lying closer to the first value than to the fourth value and the second intermediate value lying closer to the fourth value than to the first value, and creating a sequence of content items, the sequence of content items comprising the second content item and the third content item, the third content item succeeding the second content item in the sequence.

In an embodiment, the method of the invention further comprises the step of enabling a user to select at least one of a content item to be used as the first content item and a content item to be used as the fourth content item.

These and other aspects of the method and electronic device of the invention will be further elucidated and described with reference to the drawings, in which:

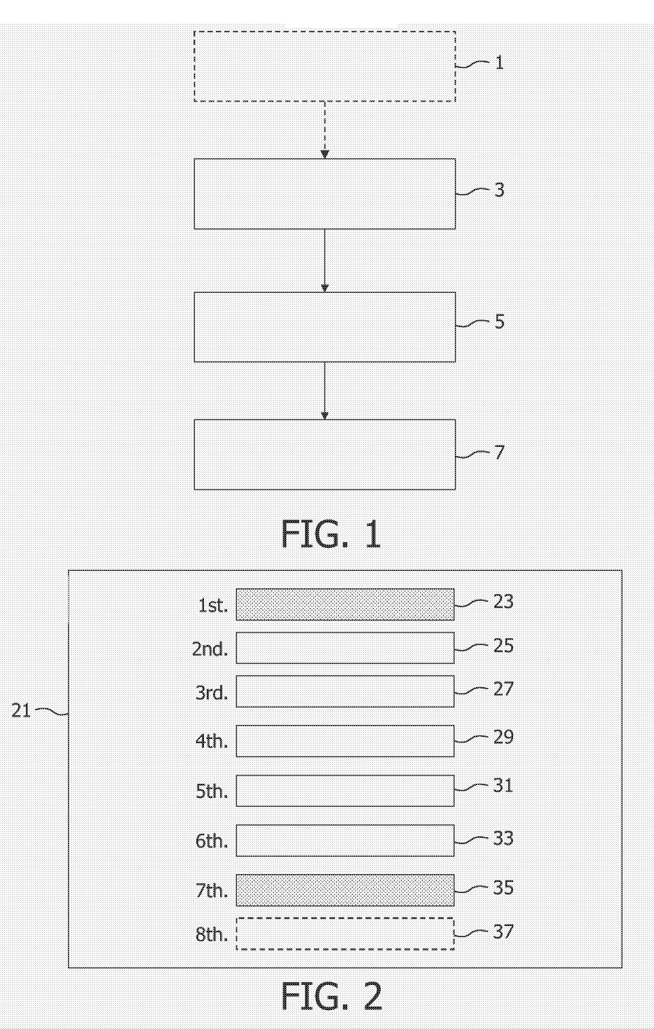

FIG. 1 is a flow diagram of the method of the invention;

FIG. 2 shows an example of a sequence generated with a first or a second embodiment of the method;

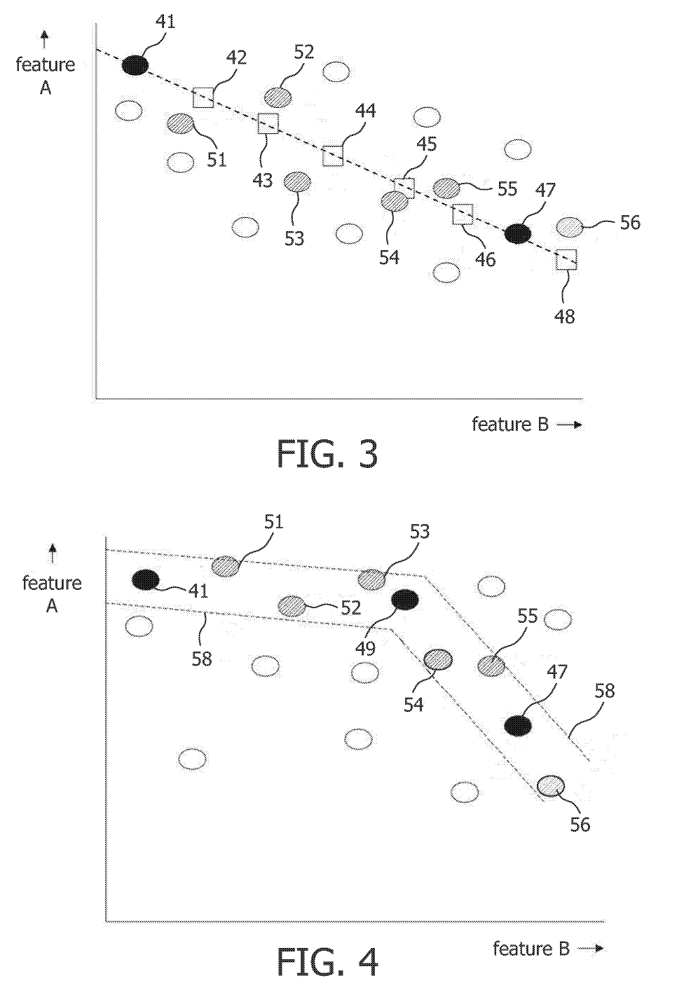

FIG. 3 illustrates the steps performed in the first embodiment of the method;

FIG. 4 illustrates the steps performed in the second embodiment of the method; and

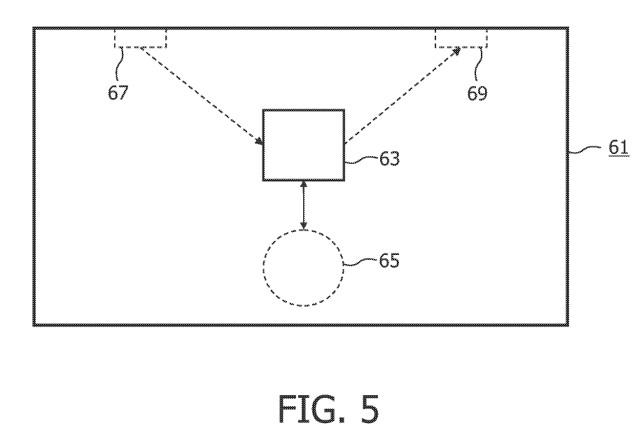

FIG. 5 is a block diagram of the electronic device of the invention.

Corresponding elements within the drawings are identified by the same reference numerals.

Referring to FIG. 1, the method of creating a sequence of content items of the invention comprises at least three steps. A step 3 comprises determining a second content item having a second value for a feature, the second value lying within a predetermined distance from a first intermediate value, the first intermediate value lying between a first value of the feature and a fourth value of the feature, the first value being designated for a first content item and the fourth value being designated for a fourth content item. A step 5 comprises determining a third content item having a third value for the feature, the third value lying within a predetermined distance from a second intermediate value, the second intermediate value lying between the first value and the fourth value, the first intermediate value lying closer to the first value than to the fourth value and the second intermediate value lying closer to the fourth value than to the first value. A step 7 comprises creating a sequence of content items, the sequence of content items comprising the second content item and the third content item, the third content item succeeding the second content item in the sequence.

The method may further comprise a step 1 of enabling a user to select at least one of a content item to be used as the first content item and a content item to be used as the fourth content item. The method may comprise further steps to determine further content items for inclusion in the sequence (e.g. positioned between step 5 and step 7). Step 1 may comprise enabling a user to select one or more content items to be used as anchor content items. The feature values of the anchor items can be used to determine which intermediate values lie between the first value and the fourth value. For example, intermediate values are taken from a line or curve which intersects the first value, the feature values of the anchor items and the fourth value.

A feature value of a content item can be considered to lie within a predetermined distance from an intermediate feature value when, for example, the distance between the two values is less than a predetermined threshold, e.g. 5 BPM and/or 5% percussiveness, or the feature value of the content item is the value that is the nearest content item feature value or one of the nearest content item feature values with respect to the intermediate value. In one embodiment, the content items are determined in such a way that the sum of all distances between content item feature values and respective intermediate values is minimized (when compared to other possible sequences).

The predetermined distance may be fixed or determined just before performing a comparison that uses the distance. By determining the distance just before a comparison that uses the distance, the distance can be adapted on the basis of a previous comparison. If no content items are found after one or more comparisons with a first distance, the one or more comparisons can be performed again, this time with a larger second distance. Similarly, if too many content items are found after one or more comparisons with a first distance, the one or more comparisons can be performed again with a smaller second distance. The distance may be adapted after one comparison or after a series of comparisons. By determining the distance just before one or more comparisons that use the distance, it also becomes possible to use a random distance that is different for each comparison or each series of comparisons. This facilitates the creation of sequences that are different, even when the ‘begin’ and ‘end’ content items are the same.

The distance between a content item feature value and an intermediate feature value (i.e. whether the value of the content item and the intermediate value are sufficiently similar) can be determined, for example, by using the method described in U.S. Pat. No. 5,918,223, herein incorporated by reference. Similarity between the value of the content item and the intermediate value does not need to be the only constraint that needs to be satisfied in order to decide that the content item should be included in the sequence of content items. Other constraints based on traditional (annotated) metadata such as, for example, genre and year and/or based on automatically extracted metadata may also need to be satisfied, if desired.

An example of a sequence generated with the method of the invention is shown in FIG. 2. In this example, a screen 21 displays a sequence of 8 content items. The sequence comprises a first content item 23, a second content item 25, further content items 27-31, a third content item 33, a fourth content item 35, and an additional content item 37. The first content item 23 and the fourth content item 35 have been selected by a user or by the method itself at the start of the execution of the method.

FIG. 3 explains how the second content item 25, the further content items 27-31, the third content item 33, and the additional content item 37 can be determined on the basis of the first content item 23 and the fourth content item 35 in a first embodiment of the method. In this first embodiment, a feature value of a content item is considered to lie within a predetermined distance from an intermediate feature value when the feature value of the content item is the value that is the nearest content item feature value. In this example, two different features are used, resulting in a 2-dimensional feature space. The feature values referred to in this example are thus feature vectors. First, a first feature value 41 of the first content item 23 and a fourth feature value 47 of the fourth content item 35 are determined. Secondly, a line between the first feature value 41 and the fourth feature value 47 is determined. In another embodiment, this may also be a curve. Thirdly, a first intermediate value 42, further intermediate feature values 43-45, and a second intermediate value 46 are determined on the line. The intermediate feature values are preferably equidistant, but this is not essential. The amount of intermediate feature values (and content items) may be user-selectable. Subsequently, for each intermediate feature value, a content item is determined which has a feature value that lies within a predetermined distance from the corresponding intermediate value. The result is a sequence comprising successively a second content item 25 having a feature value 51, further content items 27-31 having feature values 52-54, and a third content item 33 having a feature value 55. Optionally, additional content items may be determined by extending the line on one or both sides. In the example of FIG. 4, an additional feature value 48 has been determined. For each additional feature value, an additional content item is determined which has a feature value that lies within a predetermined distance from the corresponding additional feature value. In the example of FIGS. 3 and 4, this results in additional content item 37 having a feature value 56.

FIG. 4 explains how the second content item 25, the further content items 27-31, the third content item 33, and the additional content item 37 of FIG. 2 can be determined in a second embodiment of the method. In this second embodiment, a feature value of a content item can be considered to lie within a predetermined distance from an intermediate feature value when the distance between the two values is less than a predetermined threshold. Instead of taking intermediate values as a starting point, the content items are taken as a starting point. In its second embodiment, the method first determines the feature value of a content item and subsequently determines whether the feature value lies within a cylinder around the previously mentioned line or curve. The radius of the cylinder corresponds to the predetermined threshold. Whether a feature value lies within the cylinder depends on whether the feature value lies within a predetermined distance from an intermediate value on the line or curve. The intermediate value is, for example, the value on the line or curve that is nearest to the feature value. The predetermined distance may depend on, for example, the number of songs required, the density of the song database around the line or curve, and default or user-specified similarity constraints.

In FIG. 4, a cylinder 58 has been determined around a (virtual) line between a first feature value 41 of a first content item 23 and an anchor feature value 49 of an anchor content item (not shown in FIG. 2) and around a (virtual) line between the anchor feature value 49 and the fourth feature value 47 of the fourth content item 35. For each content item in a plurality of content items (e.g. in a user's music collection), a feature value is determined and it is determined whether the feature value lies within the cylinder 58. In FIG. 4, features values 51-56 have been determined to lie within the cylinder 58. Corresponding content items 25-33 and 37 are selected for inclusion in the sequence by traversing the (virtual) line or curve and successively including the content items corresponding to the nearest feature values one by one (i.e. in that order).

Referring to FIG. 5, the electronic device 61 of the invention comprises electronic circuitry 63. The electronic circuitry 63 is operative to determine a second content item having a second value for a feature, the second value lying within a predetermined distance from a first intermediate value, the first intermediate value lying between a first value of the feature and a fourth value of the feature, the first value being designated for a first content item and the fourth value being designated for a fourth content item. The electronic circuitry 63 is further operative to determine a third content item having a third value for the feature, the third value lying within a predetermined distance from a second intermediate value, the second intermediate value lying between the first value and the fourth value, the first intermediate value lying closer to the first value than to the fourth value and the second intermediate value lying closer to the fourth value than to the first value. The electronic circuitry 63 is also operative to create a sequence of content items, the sequence of content items comprising the second content item and the third content item, the third content item succeeding the second content item in the sequence.

The electronic device 61 may be, for example, a server PC, a stationary audio and/or video player (e.g. a home PC), a car audio and/or video player or a portable audio and/or video player. The electronic circuitry 63 may be a general-purpose processor (e.g. Intel Pentium or AMD Athlon) or an application-specific processor (e.g. a Philips Nexperia IC). The electronic device 61 may further comprise a storage means 65, an input 67 and an output 67. The storage means 65 may comprise, for example, volatile or non-volatile RAM (e.g. flash memory or magnetic memory), a hard disk, an optical disc and/or a holographic storage medium. The content items and/or the sequence of the content items may be stored on the storage means 65. The sequence of the content items may be stored, for example, as a text file that comprises an ordered list of song identifiers (e.g. titles and artists). Although possible, it is not necessary to store the content items in the sequence as one larger content item on the storage means 65. The input 67 may comprise, for example, an optical or electric (digital or analog) input, possibly for receiving video as well as audio. The output 67 may comprise, for example, an optical or electric (digital or analog) output, possibly for transmitting video as well as audio. The output 67 may alternatively or additionally comprise a reproduction means for reproducing the content items in the created sequence. The input 67 and/or the output 69 may comprise one or more network adapters connected to a home network and/or to the Internet. For example, the output 69 of a server PC may be used to transfer a song (e.g. MP3 file) and/or the sequence to the input 67 of a consumer electronics device, e.g. a home PC.

While the invention has been described in connection with preferred embodiments, it will be understood that modifications thereof within the principles outlined above will be evident to those skilled in the art, and thus the invention is not limited to the preferred embodiments but is intended to encompass such modifications. The invention resides in each and every novel characteristic feature and each and every combination of characteristic features. Reference numerals in the claims do not limit their protective scope. Use of the verb “comprise” and its conjugations does not exclude the presence of elements or steps other than those stated in the claims. Use of the article “a” or “an” preceding an element or step does not exclude the presence of a plurality of such elements or steps.

As will be apparent to a person skilled in the art, ‘means’ are understood to include any hardware (such as separate or integrated circuits or electronic elements) or software (such as programs or parts of programs) which perform in operation or are designed to perform a specified function, be it solely or in conjunction with other functions, be it in isolation or in co-operation with other elements. The invention can be implemented by means of hardware comprising several distinct elements, and by means of a suitably programmed computer. ‘Software’ is to be understood to mean any software product stored on a computer-readable medium, such as a floppy disk, downloadable via a network, such as the Internet, or marketable in any other manner.

1-9. (canceled)

10. Electronic circuitry (63) being operative to:
to select or to enable a user to select at least a content item to be used as a first content item (23) and a content item to be used as a fourth content item (35);
determine a second content item (25) having a second value (51) for a feature, the second value lying within a predetermined distance from a first intermediate value (42), the first intermediate value lying between a first value (41) of the feature and a fourth value (47) of the feature, the first value being designated for the first content item (23) and the fourth value being designated for the fourth content item (35);
determine a third content item (33) having a third value (55) for the feature, the third value lying within a predetermined distance from a second intermediate value (46), the second intermediate value lying between the first value (41) and the fourth value (47), the first intermediate value (42) lying closer to the first value (41) than to the fourth value (47) and the second intermediate value (46) lying closer to the fourth value (47) than to the first value (41); and
create a sequence of content items (23-37), the sequence of content items comprising the second content item (25) and the third content item (33), the third content item (33) succeeding the second content item (25) in the sequence.

11. The electronic circuitry as claimed in claim 10, wherein the sequence of content items further comprises the first content item and the fourth content item, the second content item succeeding the first content item in the sequence and the fourth content item succeeding the third content item in the sequence.

12. The electronic circuitry as claimed in claim 10, wherein the feature comprises a plurality of features.

13. The electronic circuitry as claimed in claim 10, wherein the content items are songs.

14. An electronic device (61) comprising the electronic circuitry of claim 10.

15. A method of creating a sequence of content items, the method comprising the steps of:
selecting or enabling (1) a user to select at least a content item to be used as a first content item and a content item to be used as a fourth content item;
determining (3) a second content item having a second value for a feature, the second value lying within a predetermined distance from a first intermediate value, the first intermediate value lying between a first value of the feature and a fourth value of the feature, the first value being designated for the first content item and the fourth value being designated for the fourth content item;
determining (5) a third content item having a third value for the feature, the third value lying within a predetermined distance from a second intermediate value, the second intermediate value lying between the first value and the fourth value, the first intermediate value lying closer to the first value than to the fourth value and the second intermediate value lying closer to the fourth value than to the first value; and
creating (7) a sequence of content items, the sequence of content items comprising the second content item and the third content item, the third content item succeeding the second content item in the sequence.

16. Software for making a programmable device operative to perform the method of claim 15.
